(19) United States
(12) Patent Application Publication
(10) Pub. No.: US 2020/0165391 A1
(43) Pub. Date: May 28, 2020

(54) POLYIMIDE POLYMER, AND POLYIMIDE FILM INCLUDING THE SAME, AND MANUFACTURING METHOD OF POLYIMIDE FILM

(71) Applicant: MORTECH CORPORATION, Taoyuan City (TW)

(72) Inventors: Der-Jen SUN, Taoyuan City (TW); Chi Sheng CHEN, New Taipei City (TW); Chang Lin LU, New Taipei City (TW)

(73) Assignee: MORTECH CORPORATION, Taoyuan City (TW)

(21) Appl. No.: 16/217,698

(22) Filed: Dec. 12, 2018

(30) Foreign Application Priority Data
Nov. 22, 2018 (TW) 107141675

(51) Int. Cl. C08G 73/10; C08J 5/18

(52) U.S. Cl. CPC C08G 73/1071; C08J 2379/08; C08J 5/18

(57) ABSTRACT

A polyimide polymer includes a first monomeric unit from dianhydride and a second monomeric unit from diamine, and the dianhydride includes 1,4-bis(3,4-dicarboxyphenoxy)benzene dianhydride (HQDPA), and coefficient of thermal expansion (CTE) is below 60 ppm/° C. The polyimide film includes a film layer, and the film layer includes the above polyimide polymer. The film layer optionally includes a pigment and an inorganic nanoparticle. Therefore, the thermal resistance and the transparency of the polyimide film are improved, and the polyimide film having high thermal resistances with different colors is available.

### CROSS-REFERENCE TO RELATED APPLICATIONS

This non-provisional application claims priority under 35 U.S.C. § 119(a) on Patent Application No(s). 107141675 filed in Taiwan, R.O.C. on Nov. 22, 2018, the entire contents of which are hereby incorporated by reference.

### BACKGROUND

### 1. Technical Field

This disclosure relates to a polyimide polymer, a polyimide film including the same, and a manufacturing method of the polyimide film, and more particularly to a polyimide polymer with high heat resistance, good flexibility, and high transparency, and a polyimide film with various color and good flexibility including the same.

### 2. Related Art

With the development of technology, traditional display devices and touch panels could not meet requirements of consumers. Therefore, flexible electronic products are developed. Firstly, a basic requirement for materials of display panels and touch panels is that the material has good optical transmittance, which makes contents displayed on the electronic products clear to users.

Secondly, because the traditional display devices and the touch panels are not flexible, glass substrates are good enough to meet the optical transmittance requirement of the traditional display devices and the touch panels. However, the glass substrate is thick, heavy and fragile so that another kind of substrate is developed to replace the glass substrate. Moreover, flexible electronic products require flexible transparent substrates. Thus, plastic substrates which are flexible and have high transparency are in the limelight in the field.

In addition, since a conducting layer need to be set on the transparent plastic substrates in the manufacturing process of display panels and touch panels, the transparent plastic substrates must be able to endure the high temperature without generating any damage during the manufacturing process of semiconductors. Generally speaking, the transparent plastic substrates must be able to endure the high temperature such that there is no damage being generated on the transparent plastic substrates during the manufacturing process of semiconductors.

In addition, since a conducting layer need to be set on the transparent plastic substrates in a manufacturing process of display panels and touch panels, the coefficient of thermal expansion (CTE) of the transparent plastic substrates is required to be close to the CTE of the material of the conducting layer. Thereby, abnormal conduction caused by break or deformation in the conducting layer due to the excessive difference in CTE between plastic substrates and the conducting layer can be prevented.

Polyimide (PI) thin film has good characteristics of flexibility, lightness, heat endurance and is widely used in semiconductor products. However, owing to the charge transfer complex effect of the polyimide thin film, the color of the polyimide is usually yellow or red-brown. The color transition is unfavorable to the substrate of display panels and touch panels, and this is a problem which should be improved.

Here, when the polyimide thin film is utilized in the flexible display panels and touch panels of flexible electronic products, the polyimide thin film has a trilemma that high heat resistance, good flexibility and good transparency cannot be maintained at the same time. How to overcome the trilemma is a topic on which many researchers are focus.

### SUMMARY

The disclosure is provided with a polyimide polymer with high heat resistance, good flexibility and good transparency and a polyimide film including the polyimide polymer.

An embodiment of the present disclosure provides a polyimide polymer including a first monomeric unit from a dianhydride and a second monomeric unit from a diamine, wherein the dianhydride includes 1,4-bis(3,4-dicarboxyphenoxy)benzene dianhydride (HQDPA), and a coefficient of thermal expansion (CTE) of the polyimide polymer is below 60 ppm/° C.

Another embodiment of the disclosure provides a manufacturing method of a polyimide film including mixing diamine, dianhydride and a solvent to form polyamic acid solution; heating the polyamic acid solution to form a polyamic film; and imidizing the polyamic film to form a polyimide film, wherein the dianhydride includes 1,4-bis(3,4-dicarboxyphenoxy)benzene dianhydride (HQDPA), and coefficient of thermal expansion (CTE) of the polyimide film is below 60 ppm/° C.

Another embodiment of the disclosure provides a polyimide film including a film layer, wherein the film layer includes the polyimide polymer of the present disclosure.

The above embodiments of the present disclosure provide a polyimide polymer and a polyimide film including the same, wherein that the polyimide polymer includes a first monomeric unit from a dianhydride, and the dianhydride includes HQDPA. As a result, the polyimide polymer and the polyimide film including the same according to above embodiments of the present disclosure have high heat resistance, good flexibility and good transparency, so that it can be used as materials for display panels, touch panels, and flexible printed circuit boards.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

An embodiment of the present disclosure provides a polyimide polymer including a dianhydride and a diamine, wherein the diahydride includes HQDPA. In addition, the polyimide polymer according to an embodiment of the present disclosure is formed by polycondensation from the diamine and the dianhydride.

In an embodiment of the present disclosure, a mole ratio of dianhydride to diamine is 0.9:1.1˜1.1:0.9, but the present disclosure is not limited thereto. In another embodiment of the present disclosure, the mole ratio of dianhydride to diamine is 0.95:1.05˜1.05:0.95, but the present disclosure is not limited thereto.

In an embodiment of the present disclosure, the mole number of HQDPA to the total mole number of dianhydride and diamine is 1˜50%, but the present disclosure is not limited thereto. In another embodiment of the present disclosure, the mole number of HQDPA to the total mole number of dianhydride and diamine is 5˜50%, but the present disclosure is not limited thereto.

In an embodiment of the present disclosure, the dianhydride of the polyimide polymer, except for including HQDPA, further includes biphenyl-tetracarboxylic acid dianhydride (BPDA, Cas.2420-87-3), 2,2-bis [4-(3,4dicarboxyphenoxy) phenyl] propane dianhydride (BPADA), 1,2,4,5-benzene tetracarboxylic dianhydride (PMDA), 3,4,3′,4′-biphenyl tetracarboxylic dianhydride, 2,3,3′,4′-biphenyl tetracarboxylic dianhydride, 4,4′-oxydiphthalic anhydride, 3,4′-oxydiphthalic anhydride, benzophenonetetracarboxylic dianhydride, 3,3′,4,4′-diphenyl sulfonetetracarboxylic dianhydride, 9,9-bis(3,4-dicarboxyphenyl)fluorene dianhydride (BPAF, Cas.135876-30-1), 9,9-bis[4-(3,4-dicarboxyphenoxt)phenyl]fluorene dianhydride (Cas.59507-08-3), 1,2,5,6-naphthalene tetracarboxylic dianhydride, naphthalenetetracaboxylic dianhydride, bis(3,4-dicarboxyphenyl)dimethylsilane dianhydride, 1,3-bis(4′-phthalic anhydride)-tetramethyldisiloxane, or bis(1,3-dioxo-1,3-dihydroisobenzofuran-5-carboxylic acid)biphenyl-3,3′-diyl ester (BP-TME).

In an embodiment of the present disclosure, the diamine of the polyimide polymer includes 2,2′-bis(trifluoromethyl)benzidine (TFMB, Cas.341-58-2), p-phenylenediamine (PPDA), 2,2-bis[4-(4-aminophenoxy)phenyl]hexafluoropropane (HFBAPP), 2,2′-bis(trifluoromethyl)-4,4′-diaminodiphenyl ether (6FODA), 4,4′-oxybis[3-(trifluoromethyl)benzeneamine] (BTFDPE), 4,4′-[1,4-phenylenebis(oxy)]bis[3-(trifluoromethyl)]benzenamine (FAPQ, Cas. 94525-05-0), 9,9-Bis(4-amino-3-fluorophenyl)fluorine (FFDA), 9,9-bis[4-(4-amino-3-fluorophenyl)bezene]fluorine or 9,9-bis(aminophenyl9fluorene) (BAFL).

In an embodiment of the present disclosure, the CTE of the polyimide polymer is below 60 ppm/° C., but the present disclosure is not limited thereto. In another embodiment of the present disclosure, the CTE of the polyimide polymer is below 50.2 ppm/° C., but the present disclosure is not limited thereto. The lower CTE of the polyimide polymer means the CTE of the polyimide polymer more close to the CTE of the conducting layer, such as copper foil, and the abnormal conduction problem caused by break or deformation in the conducting layer due to the excessive difference in the CTE between plastic substrates and materials of the conducting layer can be prevented. Due to the CTE of the polyimide polymer according to the embodiment of the present disclosure is close to the CTE of the conducting layer of the common flexible transparent substrates, the polyimide polymer according to the embodiment of the present disclosure can be applied to flexible printed circuit substrates.

In an embodiment of the present disclosure, Young's modulus of the polyimide polymer is below or equal to 4.8 MPa, but the present disclosure is not limited thereto. In an embodiment of the present disclosure, Young's modulus of the polyimide polymer is high enough so that the polyimide polymer according to an embodiment of the present disclosure shows good abrasion and scratch resistance properties. Thus, the flexible substrate requiring both flexibility and hardness can be made by the polyimide polymer according to an embodiment of the present disclosure.

In an embodiment of the present disclosure, the elongation of polyimide polymer is higher than or equal to 8%, but the present disclosure is not limited thereto. In another embodiment of the present disclosure, the elongation of polyimide polymer is higher than or equal to 23%, but the present disclosure is not limited thereto. The higher elongation means the higher degree of freedom for production and application of the polyimide polymer. In an embodiment of the present disclosure, the polyimide polymer with high elongation has a high degree of freedom for operation. Thus, the polyimide polymer as a substrate will not be broken or damaged easily during the manufacturing process of forming the film. Therefore, the polyimide polymer shows good use in the manufacturing process of display panels and touch panels.

In an embodiment of the present disclosure, the transmittance of the polyimide polymer is higher than or equal to 80%, but the present disclosure is not limited thereto. In another embodiment of the present disclosure, the transmittance of the polyimide polymer is higher than or equal to 83.5%, but the present disclosure is not limited thereto. The higher transmittance means the better penetration for light. Therefore, the high transmittance of the polyimide polymer according to the embodiment of the present disclosure means more light can penetrate the polyimide film made by the polyimide polymer. Thus, the polyimide film as a substrate can present images more clearly.

In an embodiment of the present disclosure, b* of the polyimide polymer is below 2.7. b* indicates blue-yellow color space, and the b* close to 0 means the substance is close to colorless. Due to the b* of the polyimide polymer in an embodiment of the present disclosure close to 0, the polyimide polymer is close to colorless so that it can be used, for example, in display panels, touch panels, cover film and the like.

An embodiment of the present disclosure provides a polyimide film including a film layer, wherein the polyimide film includes the polyimide polymer according to the present disclosure. The thickness of the polyimide film can be various with different application in different fields, and usually is 15 μm˜100 μm. Owing to the good flexibility, high heat resistance and good transparency, the polyimide film can be used as a material of a flexible substrates.

In an embodiment of the present disclosure, for increasing the transmittance of display panels to improve the clarity of display devices, there are some inorganic nanoparticles can be dispersed in the film layer to increase the transmittance of the polyimide film. Moreover, since the polyimide film is required to endure the high temperature and be undamaged during the manufacturing process of semiconductors, dispersing inorganic nanoparticles in the polyimide film can improve the heat resistance of the polyimide film according to an embodiment of the present disclosure. The inorganic nanoparticle, for example, can be silicon oxide, talcum, mica, clay or titanium dioxide, but the present disclosure is not limited thereto. The heat resistance and the transmittance of the polyimide film can be improved through dispersing inorganic nanoparticle in the polyimide film.

In addition, to meet the requirement for color of the polyimide film, the colorant can be dispersed in the film layer. The polyimide film with high heat resistance can be in various color by dispersing colorant in the film layer. The colorant, for example, can be titanium dioxide powder, aluminum oxide, calcium carbonate, silicon dioxide, boron nitride, carbon black, ultramarine or phthalocyanine, but the present disclosure is not limited thereto. For example, when using the polyimide film as a material for the cover layer of LED light bar, in addition to adding titanium dioxide powder to improve reflectance, a little blue colorant can be added to adjust the chromaticity coordinates of the LED light bar.

People in the industry are devoted to developing light, thin, flexible and high transparent substrate, and thus the plastic substrate which shows enough flexibility and transparency is required. In an embodiment of the present disclosure, the polyimide polymer and the polyimide film including the same have enough flexibility and transparency to be used as a flexible plastic substrate. In addition, the polyimide polymer in the embodiment of the present disclosure has high elongation and can be applied to the technical fields such as liquid-crystal display (LED), flexible OLED, flexible OLED, flexible printed circuit (FPC) and electronic book with high design flexibility. Moreover, the polyimide polymer and the polyimide film including the same in the embodiment of the present disclosure have good heat resistance so as to endure the high temperature during the manufacturing process of semiconductors. The polyimide polymer and the polyimide film including the same in the embodiment of the present disclosure also have good transparency and low b* to be suitable as the material of flexible electronic products.

The manufacturing process of the polyimide polymer and the polyimide film including the same are described below, but the following methods are only for explanation. The claim scope of the present disclosure is not limited by the following methods.

In the manufacturing process of an embodiment of the present disclosure, a diamine is firstly dissolved in an aprotic solvent, such as DMF, N-methyl-2-pyrrolidone (NMP), N,N-dimethylacetamide (DMAc), m-cresol, γ-butyrolactone (GBL), or the combination of above. Subsequently, a dianhydride is added and reacts with the diamine to form polyamic acid (PAA) solution. Here, in the manufacturing process of an embodiment of the present disclosure, a diamine is dissolved in a solvent, and then a dianhydride is added, but the present disclosure is not limited thereto. Then, the polyamic acid solution is coated on the substrates and dried to form a film. Then, imidization is performed to achieve dehydration and cyclization of the polyamic acid in the film to form a polyimide film. In the process, the dehydration and cyclization of the polyamic acid can be achieved by high temperature (250° C.˜400° C.). The formed polyimide film can be removed from the substrate to be stored and used. In the manufacturing process of an embodiment of the present disclosure, a dehydranting agent (anhydride) and a catalyst (polymer incarcerated catalyst, such as tertiary amine) can also be added to dehydrate and cyclize the polyamic acid. In the manufacturing process of an embodiment of the present disclosure, the diamine and the catalyst are added at the same time, and then the dianhydride is added after the diamine being dissolved, but the present disclosure is not limited thereto. In the manufacturing process of an embodiment of the present disclosure, the dianhydride and the catalyst are added at the same time, and then the diamine is added after the dianhydride being dissolved.

In the manufacturing process of an embodiment of the present disclosure, the catalyst is tertiary amine, such as triethylenediamine (DABCO), N,N-Dimethylcyclohexylamine, 1,2-Dimethylimidazole, trimethylamine, triethylamine, tripropylamine, tributylamine, triethanolamine, N,N-dimethyl ethanol amine, N,N-diethylethanolamine, N,N,N′-triethylethylenediamine, 1-methylpyrrolidine, 1-ethylpyrrolidine, N-methyl piperidine, N-ethyl piperidine, imidazole, pyridine, picoline, 2,6-lutidine, quinoline or isoquinoline. Under 230˜320° C., using few tertiary amine as catalyst can achieve preferable imidization and decrease the etiolation of the polyimide polymer under high temperature to get the polyimide polymer with high transmittance. In an embodiment of the present disclosure, the temperature of the imidization is preferable from 250˜300° C. to obtain a polyimide polymer with higher transmittance.

### EXAMPLE 1

First, 18.18 g of TFMB and 0.33 g of isoquinoline were dissolved in DMAc. After TFMB being completely dissolved, 21.82 g of HQDPA was added into DMAc solution (a mole ratio of HQDPA to TFMB is 1:1) and stirred at least 1 hour until HQDPA reacting completely to form polyamic acid (PAA) solution. Second, the PAA solution was coated on the substrate at 120° C. and dried for 10 min to form a film. Then, the imidization was performed at 300° C. for 10 min to achieve the dehydration and cyclization of the polyamic acid to form a polyimide film. Subsequently, the polyimide film was removed from the substrate.

### EXAMPLE 1-1

100 g of PAA solution according to example 1 mixed with 25 g of SiO₂ sol-gel (solid content was 20%) was stirred at least 1 hour to form hybrid polyamic acid solution. Then, the hybrid polyamic acid solution was coated on the substrate at 120° C. and dried for 10 min to form a film. Then, the imidization was performed at 300° C. for 10 min to achieve the dehydration and cyclization of the polyamic acid to form a polyimide film. Subsequently, the polyimide film was removed from the substrate.

### EXAMPLE 2

First, 18.3 g of TFMB and 0.33 g of isoquinoline were dissolved in DMAc. After TFMB being completely dissolved, 20.86 g of HQDPA and 0.84 g of BPDA were added into DMAc solution (a mole ratio of HQDPA to BPDA to TFMB is 0.95:0.05:1) and stirred at least 1 hour until HQDPA and BPDA reacting completely to form polyamic acid (PAA) solution. Second, the PAA solution was coated on the substrate at 120° C. and dried for 10 min to form a film. Then, the imidization was performed at 300° C. for 10 min to achieve the dehydration and cyclization of the polyamic acid to form a polyimide film. Subsequently, the polyimide film was removed from the substrate.

### EXAMPLE 2-1

100 g of PAA solution according to example 2 mixed with 25 g of SiO₂ sol-gel (solid content was 20%) was stirred at least 1 hour to form hybrid polyamic acid solution. Then, the hybrid polyamic acid solution was coated on the substrate at 120° C. and dried for 10 min to form a film. Then, the imidization was performed at 300° C. for 10 min to achieve the dehydration and cyclization of the polyamic acid to form a polyimide film. Subsequently, the polyimide film was removed from the substrate.

### EXAMPLE 3

First, 18.78 g of TFMB and 0.33 g of isoquinoline were dissolved in DMAc. After TFMB being completely dissolved, 16.91 g of HQDPA and 4.31 g of BPDA were added into DMAc solution (a mole ratio of HQDPA to BPDA to TFMB is 0.75:0.25:1) and stirred at least 1 hour until HQDPA and BPDA reacting completely to form polyamic acid (PAA) solution. Second, the PAA solution was coated on the substrate at 120° C. and dried for 10 min to form a film. Then, the imidization was performed at 300° C. for 10 min to achieve the dehydration and cyclization of polyamic acid to form a polyimide film. Subsequently, the polyimide film was removed from the substrate.

### EXAMPLE 3-1

100 g of PAA solution according to example 3 mixed with 25 g of SiO₂ sol-gel (solid content was 20%) was stirred at least 1 hour to form hybrid polyamic acid solution. Then, the hybrid polyamic acid solution was coated on the substrate at 120° C. and dried for 10 min to form a film. Then, the imidization was performed at 300° C. for 10 min to achieve the dehydration and cyclization of the polyamic acid to form a polyimide film. Subsequently, the polyimide film was removed from the substrate.

### EXAMPLE 4

First, 19.42 g of TFMB and 0.33 g of isoquinoline were dissolved in 159.67 g of DMAc. After TFMB being completely dissolved, 11.66 g of HQDPA and 8.92 g of BPDA were added into DMAc solution (a mole ratio of HQDPA to BPDA to TFMB is 0.5:0.5:1) and stirred at least 1 hour until HQDPA and BPDA reacting completely to form polyamic acid (PAA) solution. Second, the PAA solution was coated on the substrate at 120° C. and dried for 10 min to form a film. Then, the imidization was performed at 300° C. for 10 min to achieve the dehydration and cyclization of the polyamic acid to form a polyimide film. Subsequently, the polyimide film was removed from the substrate.

### EXAMPLE 4-1

100 g of PAA solution according to example 4 mixed with 25 g of SiO₂ sol-gel (solid content was 20%) was stirred at least 1 hour to form hybrid polyamic acid solution. Then, the hybrid polyamic acid solution was coated on the substrate at 120° C. and dried for 10 min to form a film. Then, the imidization was performed at 300° C. for 10 min to achieve the dehydration and cyclization of the polyamic acid to form a polyimide film. Subsequently, the polyimide film was removed from the substrate.

### EXAMPLE 5

First, 20.11 g of TFMB and 0.33 g of isoquinoline were dissolved in 159.67 g of DMAc. After TFMB being completely dissolved, 6.03 g of HQDPA and 13.86 g of BPDA were added into DMAc solution (a mole ratio of HQDPA to BPDA to TFMB is 0.25:0.75:1) and stirred at least 1 hour until HQDPA and BPDA reacting completely to form polyamic acid (PAA) solution. Second, the PAA solution was coated on the substrate at 120° C. and dried for 10 min to form a film. Then, the imidization was performed at 300° C. for 10 min to achieve the dehydration and cyclization of the polyamic acid to form a polyimide film. Subsequently, the polyimide film was removed from the substrate.

### EXAMPLE 6

First, 20.55 g of TFMB and 0.33 g of isoquinoline were dissolved in 159.67 g of DMAc. After TFMB being completely dissolved, 2.47 g of HQDPA and 16.99 g of BPDA were added into DMAc solution (a mole ratio of HQDPA to BPDA to TFMB is 0.1:0.9:1) and stirred at least 1 hour until HQDPA and BPDA reacting completely to form polyamic acid (PAA) solution. Second, the PAA solution was coated on the substrate at 120° C. and dried for 10 min to form a film. Then, the imidization was performed at 300° C. for 10 min to achieve the dehydration and cyclization of the polyamic acid to form a polyimide film. Subsequently, the polyimide film was removed from the substrate.

### EXAMPLE 7

First, 20.69 g of TFMB and 0.33 g of isoquinoline were dissolved in 159.67 g of DMAc. After TFMB being completely dissolved, 1.24 g of HQDPA and 18.06 g of BPDA were added into DMAc solution (a mole ratio of HQDPA to BPDA to TFMB is 0.05:0.95:1) and stirred at least 1 hour until HQDPA and BPDA reacting completely to form polyamic acid (PAA) solution. Second, the PAA solution was coated on the substrate at 120° C. and dried for 10 min to form a film. Then, the imidization was performed at 300° C. for 10 min to achieve the dehydration and cyclization of the polyamic acid to form a polyimide film. Subsequently, the polyimide film was removed from the substrate.

### COMPARISON EXAMPLE 1

First, 20.85 g of TFMB and 0.33 g of isoquinoline were dissolved in 159.67 g of DMAc. After TFMB being completely dissolved, 19.15 g of BPDA was added into DMAc solution (a mole ratio of BPDA to TFMB is 1:1) and stirred at least 1 hour until BPDA reacting completely to form polyamic acid (PAA) solution. Second, the PAA solution was coated on the substrate at 120° C. and dried for 10 min to form a film. Then, the imidization was performed at 300° C. for 10 min to achieve the dehydration and cyclization of the polyamic acid to form a polyimide film. Subsequently, the polyimide film was removed from the substrate.

### COMPARISON EXAMPLE 1-1

100 g of PAA solution according to comparison example 1 mixed with 25 g of SiO₂ sol-gel (solid content was 20%) was stirred at least 1 hour to form hybrid polyamic acid solution. Then, the hybrid polyamic acid solution was coated on the substrate at 120° C. and dried for 10 min to form a film. Then, the imidization was performed at 300° C. for 10 min to achieve the dehydration and cyclization of the polyamic acid to form a polyimide film. Subsequently, the polyimide film was removed from the substrate.

### COMPARISON EXAMPLE 2

First, 19.15 g of ODA was dissolved in 160 g of DMAc. After ODA being completely dissolved, 20.85 g of PMDA was added into DMAc solution (a mole ratio of BPDA to ODA is 1:1) and stirred at least 1 hour until PMDA reacting completely to form polyamic acid (PAA) solution. Second, the PAA solution was coated on the substrate at 120° C. and dried for 10 min to form a film. Then, the imidization was performed at 300° C. for 10 min to achieve the dehydration and cyclization of the polyamic acid to form polyimide film. Subsequently, the polyimide film was removed from the substrate.

### COMPARISON EXAMPLE 2-1

100 g of PAA solution according to comparison example 2 mixed with 25 g of SiO₂ sol-gel (solid content was 20%) was stirred at least 1 hour to form hybrid polyamic acid solution. Then, the hybrid polyamic acid solution was coated on the substrate at 120° C. and dried for 10 min to form a film. Then, the imidization was performed at 300° C. for 10 min to achieve the dehydration and cyclization of the polyamic acid to form a polyimide film. Subsequently, the polyimide film was removed from the substrate.

The properties of the polyimide film described above was measured by the following method.

Test 1

Mechanical Property and Thermal Property

Tests contain testing of tensile property (MPa), Young's modulus (MPa), elongation (%), CTE (ppm/° C.) and glass-transition temperature (Tg). The tensile property, Young's modulus and elongation were measured by a tensile testing machine according to ASTM 822 Standard Test Method. CTE was measured by thermomechanical analyzer TMA/SDTA LF1100 (Mettler-Toledo) under the thermal stress 50˜200° C. (heating rate of 10° C./min) with standard force (about 0.2N) applied, and thus the expansion of the film was measured. Tg was measured by a thermomechanical analyzer TMA/SDTA LF1100 according to ASTM D-696-91 Standard Test Method. The data were showed in Table1 and Table2.

Test 2

Optical Property

Total luminous transmittance (transmittance, %) was measured by Cary 100/300 UV-Vis Spectrophotometer (Agilent, light source D65) according to JIS K 7361 Standard. The data were showed in Table1 and Table2.

Test 3

Color Property

Color property was measured by a spectrophotometer at room temperature. The color property was showed by Lab color space, wherein b* was defined as blue-yellow color space. The data were showed in Table1 and Table2.

TABLE 1

| | Data | | | | | | |
|---|---|---|---|---|---|---|---|
| | Tensile | Young's | | | | | |
| | property | modulus | Elongation | CTE | Tg | Transmittance | |
| | MPa | MPa | % | ppm/° C. | ° C. | % | b* |
| Example | | | | | | | |
| 1 | 107.6 | 3.53 | 25.6 | 59.5 | 241.3 | 84.3 | 2.16 |
| 2 | 111.7 | 3.67 | 27.8 | 59.3 | 246.0 | 84.2 | 2.17 |
| 3 | 117.8 | 3.85 | 26.2 | 56.1 | 259.8 | 84.1 | 2.26 |
| 4 | 128.5 | 4.02 | 23.4 | 48.4 | 281.9 | 83.9 | 2.30 |
| 5 | 142.4 | 4.34 | 20.8 | 36.0 | 303.5 | 83.1 | 2.35 |
| 6 | 158.8 | 4.65 | 15.8 | 26.3 | 305.2 | 82.9 | 2.58 |
| 7 | 167.7 | 4.78 | 9.3 | 24.03 | 316.3 | 82.8 | 2.69 |
| Comparison | | | | | | | |
| Example | | | | | | | |
| 1 | 169.7 | 4.85 | 7.6 | 24.0 | 317.6 | 82.9 | 2.72 |
| 2 | 104.4 | 3.52 | 18.5 | 42.8 | — | 58.3 | 27.3 |

TABLE 2

| | Data | | | | | | |
|---|---|---|---|---|---|---|---|
| | Tensile | Young's | | | | | |
| | property | modulus | Elongation | CTE | Tg | Transmittance | |
| | MPa | MPa | % | ppm/° C. | ° C. | % | b* |
| Example | | | | | | | |
| 1-1 | 112.9 | 3.71 | 26.2 | 58.1 | 245.4 | 84.5 | 2.12 |
| 2-1 | 116.2 | 3.78 | 28.1 | 57.4 | 249.1 | 84.7 | 2.10 |
| 3-1 | 127.5 | 4.17 | 28.4 | 52.3 | 262.4 | 84.9 | 2.08 |
| 4-1 | 132.3 | 4.29 | 27.9 | 45.4 | 290.8 | 85.2 | 1.72 |
| Comparison | | | | | | | |
| Example | | | | | | | |
| 1-1 | 172.5 | 4.89 | 7.8 | 22.9 | 321.2 | 82.9 | 2.55 |
| 2-1 | 100.8 | 3.99 | 6.2 | 50.2 | — | 62.1 | 25.1 |

As shown in Table1, in the comparison example 1, only BPDA was used as dianhydride. Though the film had high hardness, the extensibility was poor and the degree of freedom was low for operating. However, the transparent polyimide film in examples 1˜7 show significantly improved flexibility while having good CTE.

The polyimide films with a higher or equal to 10% of elongation are obtained by selecting the mole number of HQDPA to the total mole number of the dianhydride and the diamine to be 1˜50% (examples 1˜6). Therefore, the elongation of the polyimide polymer and the polyimide film including the same according to the present disclosure is higher and not easy to be broken or damaged during the process of forming film and subsequent process. Thus, the yield of the product including the same can be increased.

In addition, as shown in Table1, compare to comparison example 2 (known polyimide film which presents yellow or red-brown.), the b* of the transparent polyimide film according to examples 1˜7 of the present disclosure is close to 0, which indicates the color of the transparent polyimide film in examples 1˜7 is indeed close to colorless. Therefore, the polyimide film according to the present disclosure presents lower yellowing. Further, as shown in Table1, in the comparison example 2 the transmittance of known polyimide film was only 58.3%, but the transmittance of the polyimide film according to the present disclosure was higher than or equal to 80% and significantly superior to the polyimide film in comparison example 2. This is shown that the polyimide polymer and the polyimide film including the same can truly present the original color of the image and have suitable value of CTE at the same time.

In addition, as shown in Table 2, in the comparison example 1-1 and comparison example 2-1, when inorganic nanoparticles are added to further improve the transmittance and heat resistance, it lost original good elongation, and the operability of the polyimide film is reduced, and the polyimide film become easy to be broken or damaged during the process of forming film and subsequent process and application. In comparison, in an embodiment of the present disclosure the polyimide polymer adding inorganic nanoparticle to improve the transmittance and heat resistance still maintains high heat resistance, good flexibility and high transmittance. Therefore, the polyimide film can be the materials of substrate of display panels and touch panels.

In summary, an embodiment of the present disclosure provides the polyimide polymer and the polyimide film including the same that have high heat resistance, good flexibility and high transparency though selecting the mole number of HQDPA to the total mole number of the dianhydride and the diamine to be 1˜50%.

Though the embodiment of the present disclosure is described above, the present disclosure is not limited thereto. Without departing from the spirit and scope of the present disclosure, any skilled person in the field can do some appropriate change in the shapes, structures, characteristics and spirits. The extent of patent protection subject to the claim in the specification.

What is claimed is:

1. A polyimide polymer, comprising:
a first monomeric unit from an dianhydride; and
a second monomeric unit from a diamine;
wherein the dianhydride comprises1,4-bis(3,4-dicarboxyphenoxy)benzene dianhydride (HQDPA), and a coefficient of the thermal expansion (CTE) of the polyimide polymer is below 60 ppm/° C.

2. The polyimide polymer of claim 1, wherein the dianhydride further comprises biphenyl-tetracarboxylic acid dianhydride (BPDA, Cas.2420-87-3), 2,2-bis [4-(3,4dicarboxyphenoxy) phenyl] propane dianhydride (BPADA), 1,2,4,5-benzene tetracarboxylic dianhydride (PMDA), 3,4,3′,4′-biphenyl tetracarboxylic dianhydride, 2,3,3′,4′-biphenyl tetracarboxylic dianhydride, 4,4′-oxydiphthalic anhydride, 3,4′-oxydiphthalic anhydride, benzophenonetetracarboxylic dianhydride, 3,3′,4,4′-diphenyl sulfonetetracarboxylic dianhydride, 9,9-bis(3,4-dicarboxyphenyl)fluorene dianhydride (BPAF, Cas.135876-30-1), 9,9-bis[4-(3,4-dicarboxyphenoxt)phenyl]fluorene dianhydride (Cas.59507-08-3), 1,2,5,6-naphthalene tetracarboxylic dianhydride, naphthalenetetracaboxylic dianhydride, bis(3,4-dicarboxyphenyl)dimethylsilane dianhydride, 1,3-bis(4′-phthalic anhydride)-tetramethyldisiloxane or bis(1,3-dioxo-1,3-dihydroisobenzofuran-5-carboxylic acid)biphenyl-3,3′-diyl ester (BP-TME).

3. The polyimide polymer of claim 1, wherein the diamine comprises 2,2′-bis(trifluoromethyl)benzidine (TFMB, Cas.341-58-2), p-phenylenediamine (PPDA), 2,2-bis[4-(4-aminophenoxy)phenyl]hexafluoropropane (HFBAPP), 2,2′-bis(trifluoromethyl)-4,4′-diaminodiphenyl ether (6FODA), 4,4′-oxybis[3-(trifluoromethyl)benzeneamine] (BTFDPE), 4,4′-[1,4-phenylenebis(oxy)]bis[3-(trifluoromethyl)]benzenamine (FAPQ, Cas. 94525-05-0), 9,9-Bis(4-amino-3-fluorophenyl)fluorine (FFDA), or 9,9-bis(aminophenyl9fluorene) (BAFL).

4. The polyimide polymer of claim 1, wherein a mole ratio of the dianhydride to the diamine is from 0.9:1.1˜1.1:0.9.

5. A manufacturing method of a polyimide film, comprising:
mixing a diamine, an dianhydride and a solvent to form a polyamic acid solution;
heating the polyamic acid solution to form a polyamic film; and
imidizing the polyamic film to form a polyimide film;
wherein the diamine comprises HQDPA, a CTE of the polyimide film is below 60 ppm/° C.

6. The manufacturing method of the polyimide film of claim 5, wherein the step of mixing the diamine, dianhydride and the solvent to form the polyamic acid solution comprises mixing the diamine, the dianhydride, the solvent and a catalyst to form a polyamic acid solution containing catalyst; in the step of imidizing the polyamic film to form a polyimide film, the catalyst catalyzes the imidization of the polyamic film to form the polyimide film, and the catalyst is tertiary amine.

7. The manufacturing method of polyimide film of claim 6, wherein the catalyst comprises triethylenediamine (DABCO), N,N-Dimethylcyclohexylamine, 1,2-Dimethylimidazole, trimethylamine, triethylamine, tripropylamine, tributylamine, triethanolamine, N,N-dimethylethanolamine, N,N-diethylethanolamine, N,N,N′-triethylethylenediamine, 1-methylpyrrolidine, 1-ethylpyrrolidine, N-methyl piperidine, N-ethyl piperidine, imidazole, pyridine, picoline, 2,6-lutidine, quinoline or isoquinoline.

8. The manufacturing method of polyimide film of claim 6, wherein the step of imidizing the polyamic film to form the polyimide film is performed under 230˜320° C.

9. A polyimide film, comprising:
a film layer, comprising the polyimide polymer of claim 1.

10. The polyimide film of claim 9, further comprising a colorant dispersed in the film layer, and the colorant comprises titanium dioxide powder, aluminum oxide, calcium carbonate, silicon dioxide, boron nitride, carbon black, ultramarine or phthalocyanine.

11. The polyimide film of claim 9, further comprising an inorganic nanoparticle dispersed in the film layer, and the inorganic nanoparticle comprises silicon oxide, talcum, mica, clay or titanium dioxide.

12. A polyimide film, comprising:
a film layer, comprising the polyimide polymer of claim 2.

13. The polyimide film of claim 12, further comprising a colorant dispersed in the film layer, and the colorant comprises titanium dioxide powder, aluminum oxide, calcium carbonate, silicon dioxide, boron nitride, carbon black, ultramarine or phthalocyanine.

14. The polyimide film of claim 12, further comprising an inorganic nanoparticle dispersed in the film layer, and the inorganic nanoparticle comprises silicon oxide, talcum, mica, clay or titanium dioxide.

15. A polyimide film, comprising:
a film layer, comprising the polyimide polymer of claim 3.

16. The polyimide film of claim 15, further comprising a colorant dispersed in the film layer, and the colorant comprises titanium dioxide powder, aluminum oxide, calcium carbonate, silicon dioxide, boron nitride, carbon black, ultramarine or phthalocyanine.

17. The polyimide film of claim 15, further comprising an inorganic nanoparticle dispersed in the film layer, and the inorganic nanoparticle comprises silicon oxide, talcum, mica, clay or titanium dioxide.

18. A polyimide film, comprising:
a film layer, comprising the polyimide polymer of claim 4.

19. The polyimide film of claim 18, further comprising a colorant dispersed in the film layer, and the colorant comprises titanium dioxide powder, aluminum oxide, calcium carbonate, silicon dioxide, boron nitride, carbon black, ultramarine or phthalocyanine.

20. The polyimide film of claim 18, further comprising an inorganic nanoparticle dispersed in the film layer, and the inorganic nanoparticle comprises silicon oxide, talcum, mica, clay or titanium dioxide.
